(19) United States
(12) Patent Application Publication
(10) Pub. No.: US 2003/0172819 A1
(43) Pub. Date: Sep. 18, 2003

(54) Satellite printing machine for printing sheets

(76) Inventor: Ebe Hesterman, Badhoevedorp (NL)

Correspondence Address: Jordan & Hamburg, 122 East 42nd Street, New York, NY, 10168, US

(21) Appl. No.: 09/890,506

(22) PCT Filed: Dec. 1, 2000
(86) PCT No.: PCT/EP00/12127

(30) Foreign Application Priority Data
Dec. 3, 1999 (DE) 299 21 184.3

(51) Int. Cl. B41F 1/00

(52) U.S. Cl. 101/171

(57) ABSTRACT

A satellite printing machine is provided for printing sheets, in that said printing machine comprises a single central counter-pressure cylinder (2) and a number of at least four satellite printing groups (S) which are provided for first printing and which are assigned, in a peripherally distributed manner to said counter-pressure cylinder in the rotational direction (D) thereof, between a feed system, said feed system comprising a feed cylinder (3) and an output system (4). The counter-pressure cylinder (2) is provided in the form of a rubber blanket cylinder and at least one additional satellite printing group (W), which is provided for at least single-color second printing, is assigned to said counter-pressure cylinder in the rotational direction (D) thereof, behind the output system (4) and in front of the feed system (3).

This invention relates to a satellite printing machine for printing sheets according to the preamble of Claim 1.

With known satellite printing machines (DE 43 03 796 A 1), the number of rubber and plate cylinder pairs around a printing cylinder is limited to four for reasons of accessibility to the printing groups, so that a series connection of two printing groups must be provided for first and second printing, which must be connected via a turning unit, as is provided, for example, in U.S. Pat. No. 5,660,108 and DE PS 43 59 02.

The invention deals with the problem of creating a satellite printing machine for printing sheets which, without an additional turning operation or intermediate drying, enables a multiple first printing and at least a simple second printing in only one operation, and which is operable with short setup and service times.

The invention solves this problem by means of a satellite printing machine with the characterized features of Claim 1 . Other major characteristic embodiments are described in claims 2 through 17.

The inventive satellite printing machine is provided with a single central counter-pressure cylinder developed as a rubber blanket cylinder, to which, in the rotational direction between the feed system and the output system, comprising a feed cylinder, a number of at least four to ten satellite printing groups, can be assigned for first printing, and which interacts with at least one additional satellite printing group for second printing, which is provided in the rotational direction behind the output cylinder and in front of the feed cylinder. This type of machine design enables multicolor first printing and at least single-color second printing on sheet-like printing stock, which can be printed in a single run, without additional transfer or turning technology. As there is only one counter-pressure cylinder, one is able to dispense with auxiliary cylinders or a second counter-pressure cylinder.

The compact design of the satellite printing machine enables a printing operation under even, continuous feed conditions for the printing stock, which, after the proper feed-in passes the respective satellite printing groups accordance with the register setting, because transfer problems and additional gripper and feed components are avoided by using a single gripper bite. For this reason, with sheet printing the inventive satellite printing machine is able to realize a large number of cycles and operate at full printing speed, thus also achieving high printing quality and low setup time. This system enables full-size printing of both the first and second page of the sheet, in which only a marginal strip is required for the gripper bite, which cannot be grasped from the printing surface of the plate cylinder periphery. Consequently, this considerably reduces waste of paper. The satellite printing machine also is suitable for difficult to manage printing stock, such as card stock, multi-layer packaging, etc.

In an advantageous embodiment, the two plate and rubber blanket cylinder groups of the machine respectively form cassette-shaped modular units, which are moveable from the their operating position into a service position towards the operating or drive side. In spite of the close sequence in which the satellite printing groups are arranged, a quick adjustment of the changed printing conditions, such as new printing plates, inserting images or rubber blankets, is possible, while good accessibility facilitates performing the necessary tasks. Adjustments to the printing groups can be performed in service position, even while the production processes are running.

The following description and drawings provide additional details and advantageous effects of the invention, which are illustrated in an example of the inventive satellite printing machine.

### In the drawing:

FIG. 1 shows a side elevation of the inventive satellite printing machine with satellite printing groups peripherally distributed;

FIG. 2 shows an enlarged sectional view of a satellite printing group in operating position at the central counter-pressure cylinder;

FIG. 3 shows a horizontal projection of the frame of the machine, which supports the satellite printing group;

FIG. 4 shows a basic presentation Similar to FIG. 2, with several satellite printing groups in operating position;

FIG. 5 shows a sectional view of the machine in the area of a satellite printing group, which is shown in operating condition and, after lateral displacement, in a service position;

FIG. 6 shows an enlarged horizontal view of the machine in the area of the central counter-pressure cylinder and its drive components; and

FIG. 7 shows a basic presentation of the inventive satellite printing machine with respectively four first and four second printing groups.

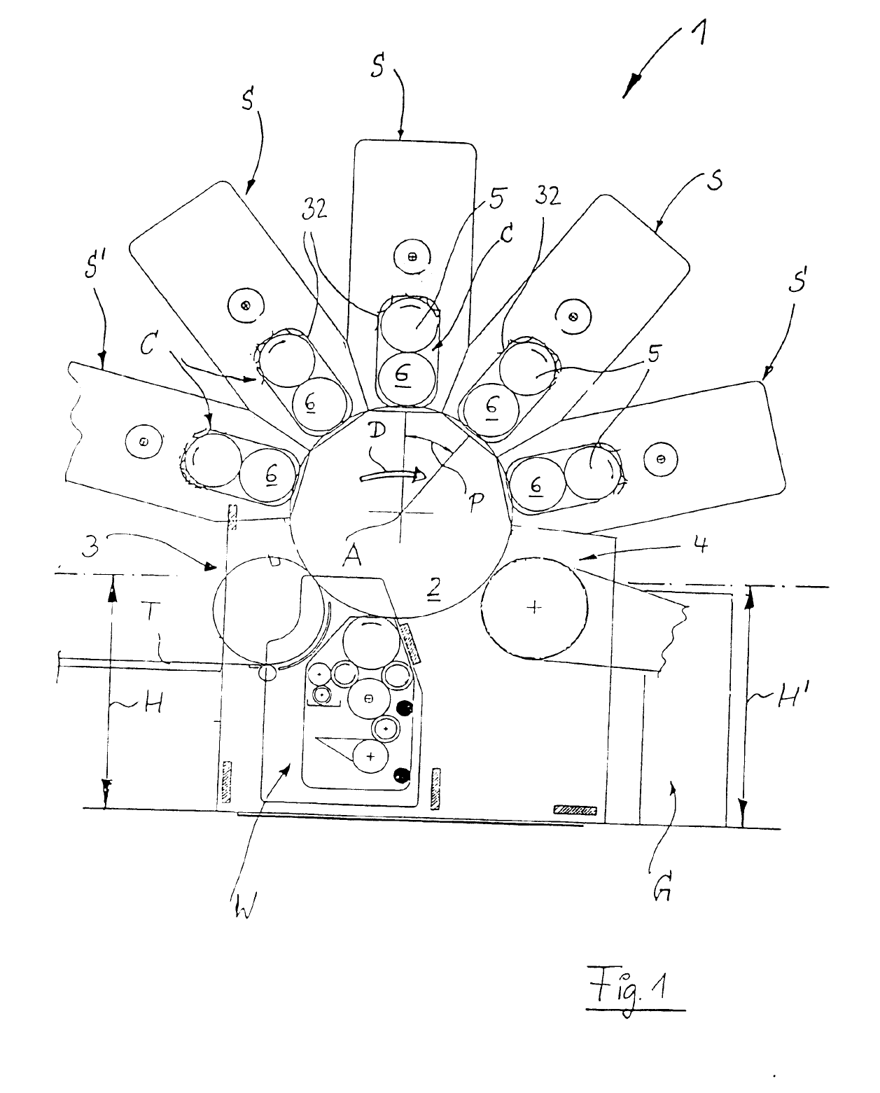

FIG. 1 shows a satellite printing machine which generally is designated 1, comprising a single central counter-pressure cylinder 2, to which more than four, i.e., five in the shown illustration, satellite printing groups S, S′ are assigned in the rotational direction D between a feed cylinder 3, which is provided as part of a feed system, and, for example, an output system 4 comprising, for example, an output cylinder.

The inventive design of the satellite printing machine 1 is provided with a counter-pressure cylinder 2, which is developed as a rubber cylinder, as well as an additional satellite printing group W for at least single-color second printing, is assigned to said cylinder in the rotational direction D behind the output system 4 and in front of the feed cylinder 3. When processing sheets as printing stock, the feed cylinder 3 and the output system 4 are developed as gripper units comprising tension elements, which are generally known, as well as tension channels (not shown). Further, an aligning table T is arranged before the feed cylinder 3, which during operation is adjustable in the transverse direction, in height and/or diagonally to the direction of feed.

The satellite printing groups S respectively comprise a plate cylinder 5 and a rubber sheet cylinder 6 which respectively form part of a cassette-shaped modular unit C within the satellite printing group S. After lifting their rubber cylinder 6, which are located adjacent to their respective printing position (FIG. 2) at the counter-pressure cylinder, said cassette units C can be moved into a service position, without tilting. This increases the long-term stability of the cassette units C, so that during printing a low-vibration printing process eliminates distortions.

The individual presentation of one of the cassette units C according to FIG. 5 illustrates their position in a machine frame which generally is designated 8, in which the cassette unit C is illustrated in the center section of the presentation within the machine frame 8, and the right side of the picture illustrates that the cassette unit, which now is designated C′, can be moved into a lateral service position adjacent to the machine frame 8 (arrow K, FIG. 5).

With this inventive concept of the satellite printing machine 1, up to ten indirect satellite printing groups S can be assigned to the counter-pressure cylinder 2 for first printing, and up to ten indirect satellite printing groups W for indirect second printing, which in a compact design may be placed directly adjacent to each other. The counter-pressure cylinder 2, in particular, is provided for full-size and double-sided printing of sheets in a single gripper bite, in which the gripper unit (not shown) requires a marginal strip at the sheet for the single gripper action and thus reduces waste of paper advantageously.

In a preferred embodiment, the counter-pressure cylinder 2 comprises a periphery of 500 to 3000 mm, and the five satellite printing groups S for first printing may be so arranged in the area of the upper arc of a circle of the counter-pressure cylinder 2, that a distance of a central angle P of 350 to 450, preferably 38°, is formed between the center planes of the satellite printing groups S (FIG. 1).

One of the printing groups W for second printing is so assigned to the above-described configuration of the satellite printing groups S that, in the peripheral area of the counter-pressure cylinder 2, which is located opposite said printing groups, the second printing can take place in the area between the feed cylinders 3 and the satellite printing group S′ which follows in the peripheral direction D of the counter-pressure cylinder 2. First and second printing taking place simultaneously in the area of this satellite printing group S′ is also feasible.

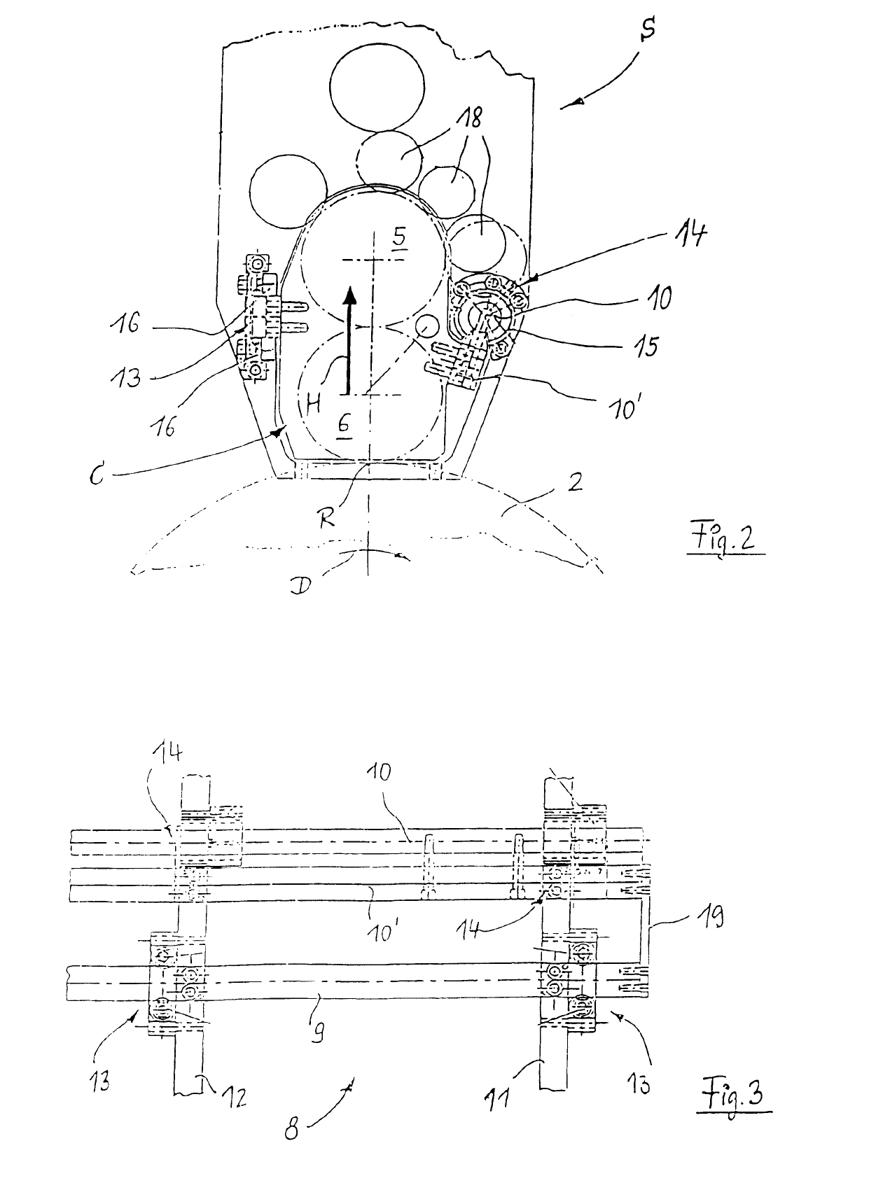

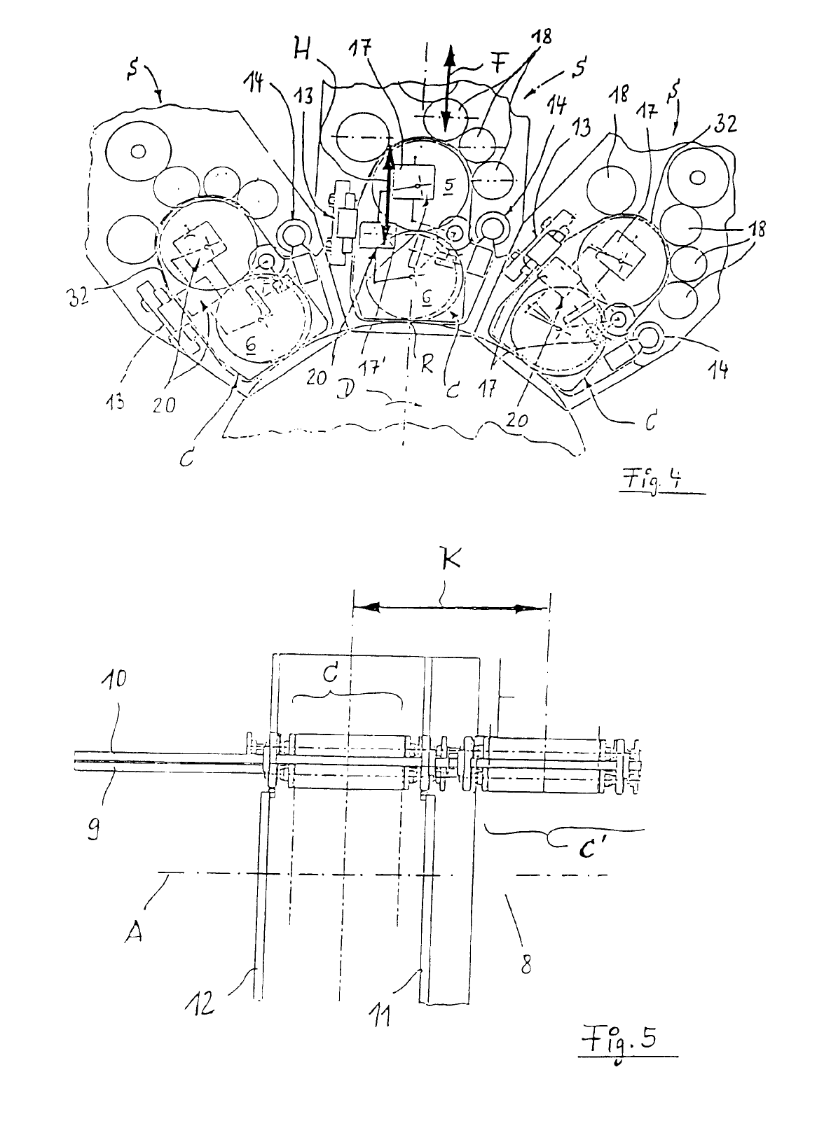

Together FIGS. 2, 3, and 5 illustrate the support of the respective cassette unit C in the area of the machine frame, comprising the plate cylinder 5 and the rubber blanket cylinder 6. Further, the cassette unit C is supported on the rails 9, 10 of the respective flank supports 11, 12 of the machine frame 8. The cassette unit C can be moved parallel on these rails 9, 10 (arrow K, FIG. 5). Respectively moving the satellite printing groups S jointly with these rails 9, 10 in guides 13, 14 of the flank supports 11, 12 is also feasible.. In the illustrated embodiment, a linear ball bearing 15 or curved rollers 16 are provided as guides 13, 14 for the respective rails 9, 10 (FIG. 2), and the rail 10 comprises a bar 10′ placed thereunder. The two rails 9 and 10 are connected via a supporting strut 19 for exact positioning displacement of the cylinders 5 and 6, so that the cassette units C are displaceable into the discharge position adjacent to the machine frame 8, as shown in FIG. 5, right-hand side, and returnable in the opposite direction into the working position.

The enlarged presentation of the plate and rubber blanket cylinders 5, 6 according to FIG. 4 illustrate that, within their cassette housing 32, said cylinders respectively can be displaced radially, individually one after the other and jointly, towards the counter-pressure cylinder 2 by means of a driving means which generally is designated 20. This radial displacement enables an adjustment to the thickness of the printing stock during operation of the machine 1, without moving or correcting the register.

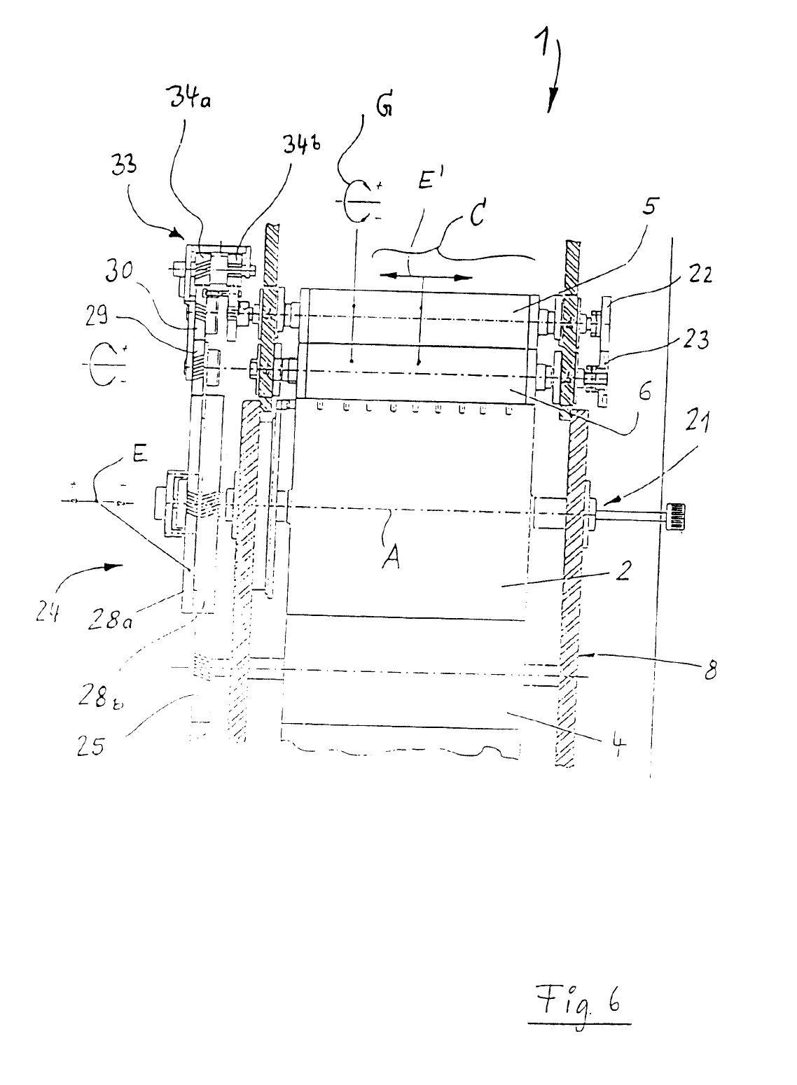

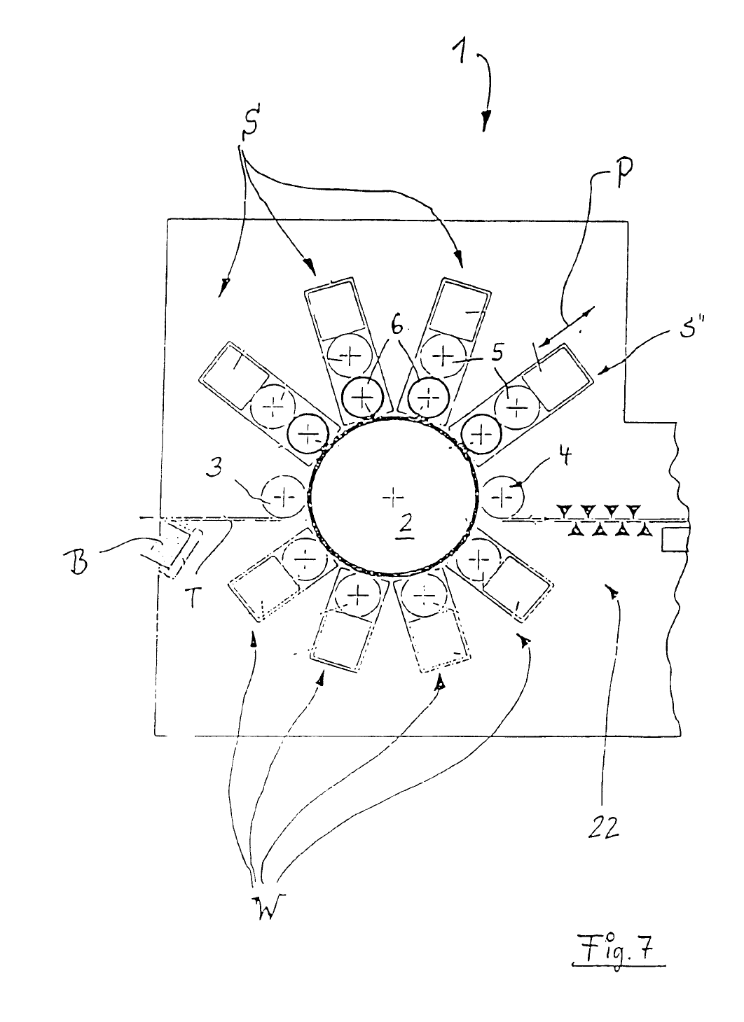

The respective pneumatic cylinders 17 as drive means 20 are feasible, in that during a first adjusting phase the respective inking rollers 18 must be lifted in a direction of the arrow F, and, thereafter, the plate and rubber blanket cylinders 5, 6 must be displaced by pneumatic cylinders 17, 17′ with a lifting motion (arrow H). Subsequently, the counter-pressure cylinder 2 is released at the peripheral side at R, and the cassette units C can be displaced, which is made possible, because the drive connection of the cylinders 5, 6 is provided by respective gear wheels 22, 23 at the side facing the direction of displacement of the cassette unit C (FIG. 6). Provide the machine 1 with a servomotor as drive (not shown) also is feasible.

In a horizontal projection, FIG. 6 shows the assignment of the counter-pressure cylinder 2 to the plate and rubber blanket cylinders 5, 6, which respectively are assigned to a cassette unit C, in which the left side of the illustration shows a gear train which passes outside the machine frame 8. The cylinders 5, 6 of the satellite printing groups S are in synchronous drive connection with the counter-pressure cylinder 2, and are adjustable jointly in their register position relative to the counter-pressure cylinder 2. This drive design enables an exact, joint register adjustment of the respective cylinders of all cassette units C. An adjusting means provided for said adjustment, which has an effect on section 28 a of a gear wheel, is designated 21. The assigned gear wheel section 28 b is unmovable and interacts with a gear wheel 25 for the drive of the output system 4, which correspondingly remains uninfluenced by the register adjustments. This adjustment between the cylinders 5, 6 of the cassette units C can also be effected, while the satellite printing machine 1 is in operation.

The gear train 24 according to FIG. 6 is provided with gear wheel sections 28 a, 28 b, 29, 30, in which gear wheel section 28 a is adjustable by means of an adjusting unit 21 in the direction of the axis A (arrow E). As a result, the gear wheels 29, 30 are subjected to torsion. In the illustrated embodiment, the gear wheel 28 a acts upon a double gear wheel 33 via the gear wheels 29 and 30, the helical gear wheel section 34 a of which is coupled with a straight-toothed gear wheel section 34 b. The cassette unit C can be displaced laterally (arrow E′) by means of said gear wheel section 34 b, so that a peripheral register adjustment (arrow G) and a lateral adjustment can he effected for the plate and rubber blanket cylinders 5, 6.

The basic presentation of the satellite printing machine 1, according to FIG. 7, shows the preferred application thereof for sheets B as printing stock, which can be grasped in the area of the feed cylinder 3, in which the cylinder 3 and the output system 4 are developed with a gripper unit (not shown). Further, an alignment table T is provided in front of the feed cylinder 3, which is adjustable in the transverse direction, in height, in the direction of feed, and/or in a diagonal to the direction of feed. Providing adjusting means (not shown in detail) on the aligning table T ' by means of which the above-described changes in the direction of feed of the printing stock can he carried out, is also feasible. These adjustments may also be made, while the satellite printing machine 1 is in operation. The aligning table is provided with vacuum conveyor belts in the area in which the respective format-dependent compartments are so disposed that loss of energy is prevented.

In one of the embodiments, which is advantageous for operating the machine 1, the feed system 3 and the output system 4 are disposed at an essentially equal height (H, H′ in FIG. 1) via a supporting plane, thus defining an approximate horizontal operating plane. Additional aggregates G can be provided for series-connected additional processing in the area of the output system 4, so that the printing stock is conveyed in a conveyor line for the purpose of varnishing, drying, etc. These heights H and H′ enable a simple loading and unloading of the machine 1 at ground level.

The inventive design of the satellite printing machine comprises modular units, which are not shown in detail, by means of which one of the satellite printing group S can be displaced for first printing, preferably in the rotational direction of the last satellite printing group S″ (FIG. 7), as a whole in a service position according to one of the arrows P. In this service position, the satellite printing group S″ can be replaced with a printing group for a different printing process, above all, flexo or silk-screen printing. Further, it is provided that the printing groups for first and second printing are arranged one after the other.

The concept of the machine 1 is so designed that any printing groups can be combined. Further, the machine is able to comprise flatbed and/or rotogravure and/or letterpress and/or silk-screen and/or xerographic and/or ink jet printing.

1. Satellite printing machine for printing sheets, comprising a single central counter-pressure cylinder (2) and a number of at least four satellite printing groups (S) for first printing, which are assigned to said cylinder in the rotational direction (D) thereof between the feed system, comprising a feed cylinder (3) and an output cylinder (4), characterized in that the counter-pressure cylinder (2) is developed as a rubber blanket cylinder and at least one additional satellite printing group (W) for at least single-color second printing is assigned to said cylinderin the rotational direction (D) thereof, behind the output system (4) and in front of the feed system (3).

2. Satellite printing machine as defined in claim 1, wherein the counter cylinder (2) is provided with a gripper unit which grabs a sheet for full-size printing on both sides of the sheet in a single gripper bite.

3. Satellite printing machine as defined in claim 1, wherein up to ten satellite printing groups (S) for first printing and up to ten satellite printing groups (W) for second printing are assigned to the counter-pressure cylinder (2).

4. Satellite printing machine as defined in one of the claims 1 through 3, wherein the counter-pressure cylinder (2) comprises a periphery of 500 to 3000 mm.

5. Satellite printing machine as defined in one of the claims 1 through 4, wherein the upper arc of a circle of the counter-pressure cylinder (2) is provided with five satellite printing groups (S), comprising an angular distance (W) of 35° to 45° to each other, preferably 38°.

6. Satellite printing machine as defined in one of the claims 1 through 5, wherein second printing is effected in the area between the feed cylinder (3) and the satellite printing group (S) which follows in the rotational direction D of the counter-pressure cylinder (2).

7. Satellite printing machine as defined in one of the claims 1 through 6, wherein in the area of the first satellite printing group (S) second and first printing occur simultaneously which follows the feed cylinder (3) in the direction of rotation D of the counter-pressure cylinder (2).

8. Satellite printing machine as defined in one of the claims 1 through 6, wherein the cylinders (5, 6) of the satellite printing groups (S) are in synchronous drive connection with the counter-pressure cylinder (2) and jointly are adjustable in the peripheral alignment relative to the counter-pressure cylinder (2).

9. Satellite printing machine as defined in one of the claims 1 through 8, wherein said machine comprises a drive with toothed-wheel gearing.

10. Satellite printing machine as defined in one of the claims 1 through 8, wherein said machine comprises a drive with one or several servomotors.

11. Satellite printing machine as defined in claims 8 or 9, wherein the cylinders (5, 6) of the satellite printing groups (S) are driven by helical gear wheels (20, 30) which mesh with a helica gear wheel (28 a) of the counter-pressure cylinder (2), in that the gear wheel is sectioned (28 b), and the gear wheel section (18 a), which meshes with the helical gear wheel (28 a), is movable by means of an adjusting unit (21) in the direction of the axis (A).

12. Satellite printing machine as defined in one of the claims 1 through 11, wherein the feed system (3) and the output system (4) are disposed at essentially the same height above a base plane of the machine and define an approximately horizontal operating level.

13. Satellite printing machine as defined in one of the claims 1 through 12, wherein an aligning table (T) is arranged before the feed cylinder (3), which during operation is adjustable in the transverse direction, in height in the direction of feed and/or diagonally to the direction of feed during the operation.

14. Satellite printing machine as defined in one of the claims 13, wherein the aligning table (T) comprises adjusting means for changing the direction of feed of the printing stock (B).

15. Satellite printing machine as defined in claims 13 or 14, wherein the aligning table (T) in the area of the vacuum conveyor belts is provided with format-dependent compartments.

16. Satellite printing machine as defined in one of the claims 1 through 15, wherein said machine comprises printing groups for flatbed and/or rotogravure and/or letterpress and/or silk-screen and/or xerographic and/or ink jet printing.

17. Satellite printing machine as defined in one of the claims 1 through 16, wherein the printing groups for first and second printing are arranged one after the other, without intermediate drying.
